(19) United States
(12) Patent Application Publication
(10) Pub. No.: US 2010/0077413 A1
(43) Pub. Date: Mar. 25, 2010

(54) Traverse with Splash-Proof Device

(75) Inventors: Yao-Ching Tsai, Guishan Shiang (TW); Jen-Chen Wu, Guishan Shiang (TW)

Correspondence Address: NIKOLAI & MERSEREAU, P.A., 900 SECOND AVENUE SOUTH, SUITE 820, MINNEAPOLIS, MN, 55402, US

(73) Assignee: Quanta Storage Inc., Guishan Shiang (TW)

(21) Appl. No.: 12/481,848

(22) Filed: Jun. 10, 2009

(30) Foreign Application Priority Data
Sep. 23, 2008 (TW) 097136584

(51) Int. Cl. G11B 17/04

(52) U.S. Cl. 720/601; G9B/17.013

(57) ABSTRACT

The invention provides a traverse with a splash-proof device which disposes a spindle on one end of a body and is covered by a protection plate. A feeding device utilizes a feeding motor to rotate a screw bar, and two guiding bars, paralleling the screw bar are individually disposed on the two sides of the body. A pick-up head is disposed across two guiding bars and one side is driven h)y the screw bar to slide along the two guiding bars. The splash-proof device utilizes stick slices between the guiding bars and the protection plate to prevent lubricant from splashing.

### FIELD OF THE INVENTION

The present invention relates to a traverse of the optical disk device, and in particular to a splash-proof device dealing with a taint of the splashing lubricant caused by the high-speed rotation of the feeding device with the pick-up head of the traverse.

### BACKGROUND OF THE INVENTION

With demands of the high-solution video, the capacity of the blue-ray disc has rapidly raised. The optical disk device needs to move the pick-up head in higher speed in short time along the radial direction of the optical disc rotating in high speed in order to search and read/write the data needed on the optical disc.

FIG. 1 shows the structure of a conventional optical disk device. For instance, the slot-in optical disk device (1) includes a traverse (3) inside a hollow case (2). A spindle (4) is disposed on the traverse (3) to rotate the optical disc (5) in high speed. A feeding device (6) is disposed on one side of the spindle (4) to rotate a screw bar (8) by using a feeding motor (7) in order to backward and forward a pick-up head (9) to a master guiding bar (10a) and a slave guiding bar (10b) disposed in parallel along the radial direction of the optical disc (5). In order to decrease the friction, a lubricant is smeared around the master guiding bar (10a) and the slave guiding bar (10b). The pick-up head (9) projects and focuses a laser beam on the optical disc (5) to read the data mark on the optical disc (5) according to the signal strength of the catoptric light reflected by the optical disc (5), transferring to the optical disk device (1) via a bus line (11) connected to the pick-up head (9) and a circuit board (12).

Although a protection plate (13) is paved on the traverse (3) to isolate the feeding device (6) from the optical disc (5) in the high speed rotation in the traverse (3) in order to protect the optical disc (5), the rapid sliding movement of the pick-up head (9) on the master guiding bar (10a) and the slave guiding bar (10b) scrapes down the lubricant smeared on the master guiding bar (10a) and the slave guiding bar (10b) and causes the lubricant to splash everywhere, to cumulatively drip, and to taint the optical disk device. In addition, a through hole is usually disposed on the protection plate (13) of the traverse (3) in order to avoid interferences of the mechanism, light the protection pate (13) or assemble components easily. For instances the through hole (14) is disposed on the protection plate (13) of the slot-in optical disk device (1) in order to reserve the moving path of a guiding shaft (15) orientating the optical disc (5). It causes the lubricant to splash on the optical disc (5) via the through hole (14), and the optical disc (5) may be lightly tainted or seriously changed on its reflection rate to influence the accuracy of reading or writing data. Hence there are still problems to be solved about the lubricant splash-proof structure of the conventional optical disk device.

### SUMMARY OF THE INVENTION

An objective of the present invention is to provide a traverse with a splash-proof device, which disposes a splash-proof device on the bottom of a protection plate around a master and a slave guiding bars to prevent a splashing lubricant tainting the optical disk device.

Another objective of the present invention is to provide a traverse with a splash-proof device, which uses a splash-proof device to cover a through hole on a protection plate and to prevent a splashing lubricant tainting the optical disk device.

A further objective of the present invention is to provide a traverse with a splash-proof device, among which extends the range that a splash-proof device is disposed on the bottom of a protection plate, to increase the coverage and to use the splash-proof device against the friction of a bus line in order to decrease the cost.

In order to achieve the foregoing objectives of the invention, a traverse with a splash-proof device according to the present invention comprises a spindle disposed on one end of a body covered by a protection plate on its top surface; a feeding device rotating a screw bar by a motor, and two guiding bars paralleling the screw bar, disposed individually on the two sides of the body; both sides of a pick-up head set individually in the two guiding bars, and one side of the pick-up head driven by the screw bar to slide along the two guiding bars; and a stick slice of the splash-proof device disposed on the bottom of the protection plate between the two guiding bars and the protection plate to prevent the lubricant splashed by the two guiding bars.

A further embodiment of the present invention is to provide a traverse with a splash-proof device, which comprises a spindle disposed on one end of a body covered by a protection plate on its top surface, and at least one through hole disposed on the protection plate; a feeding device rotating a screw bar by a motor, two guiding bars paralleling the screw bar, disposed individually on the two sides of the body, and the through hole located near the two guiding bars; both sides of a pick-up head disposed individually on the two guiding bars, and one side of the pick-up head driven by the screw bar to slide along the two guiding bars; and a splash-proof device disposed on the bottom of the protection plate and covering the through hole.

Wherein one of the two guiding bars which is close to the screw bar, is a master guiding bar, the other one of the two guiding bars which is distant from the screw bar, is a slave guiding bar which the through hole are located nearby, and the splash-proof device covering the through hole, covers a range to prevent the lubricant splashing from the slave guiding bar to the protection plate. The pickup head is connected to a bus line, and the splash-proof device extends to cover the path between the bus line and the bottom of the protection plate contacting the bus line and to be used against the friction of the bus line.

### BRIEF DESCRIPTION OF THE DRAWINGS

FIG. 1 is a diagram showing the operation of the conventional optical disk device;

FIG. 2 is an exploded view showing the backside of the traverse with the splash-proof device according to the first embodiment of the invention;

FIG. 3 is a rear view showing the traverse with the splash-proof device according to the first embodiment of the invention;

FIG. 4 is a diagram showing the operation of the traverse with the splash-proof device according to the first embodiment of the invention;

FIG. 5 is a rear view shoving the traverse with the splash-proof device according to the second embodiment of the invention;

FIG. 6 is a rear view showing the traverse with the splash-proof device according to the third embodiment of the invention; and

FIG. 7 is a diagram showing the operation of the traverse with the splash-proof device according to the third embodiment of the invention.

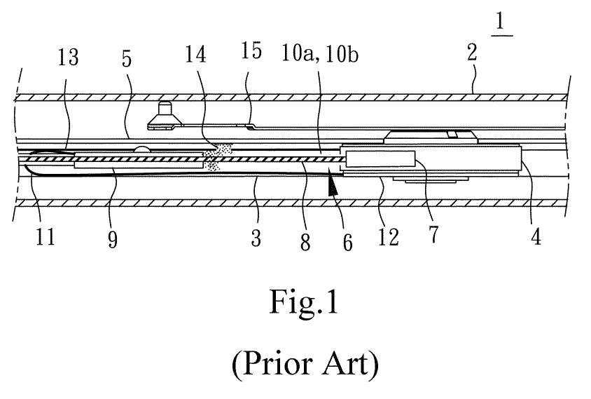

### DETAILED DESCRIPTION OF THE INVENTION

The techniques employed by the present invention to achieve the foregoing objectives and the effects thereof are described hereinafter by way of examples with reference to the accompanying drawings.

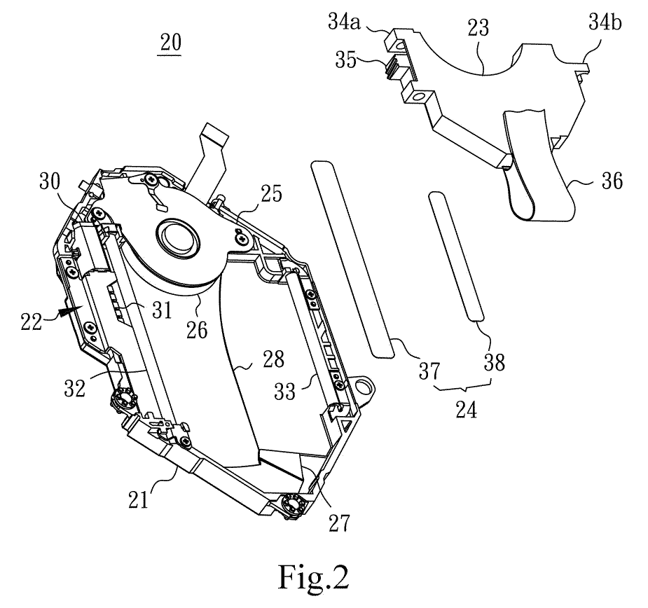

FIG. 2 is an exploded view showing the backside of the traverse with the splash-proof device according to the first embodiment of the invention. Referring to FIG. 2, the traverse (20) comprises a body (21), a feeding device (22), a pick-up head (23) and a splash-proof device (24). The body (21) of the traverse (20) is basically a polygonal plate, and one end of the body (21) is supported by a circuit board (25) to fix a spindle (26). The top surface of the body (21) is covered by a protection plate (27) dug a slot (28) along the radial direction of the spindle (26) and the major axis of the body (21).

The feeding device (22) is disposed across both sides inside the traverse (20), which includes a feeding motor (30), a screw bar (31), a master guiding bar (32) and a slave guiding bar (33). The feeding motor (30) is disposed on the body (21) near the side of the spindle (26). The screw bar (31), paralleling the slot (28), is disposed on the body (21), and the one end of the screw bar (31) is driven by the feeding motor (30). The master guiding bar (32) and the slave guiding bar (33), paralleling the screw bar (31), are individually disposed on the two sides of the body (21). The master guiding bar (32) is disposed on the side near the screw bar (31) of the body (21), and the slave guiding bar (33) is disposed on the other side that is distant from the screw bar (31) and close to the slot (28) of the body (21). Two slides (34a and 34b) are individually disposed on the two sides of the pick-up head (23), and a rack (35) is disposed on the side that is close to the master guiding bar (32) of the pick-up head, protruding to the screw bar (31). One end of the pick-up head (23) is connected to one end of a bus line (36). The splash-proof device (24) includes a master stick slice (37) and a slave stick slice (38) which are slice shapes. The size of the master stick slice (37) fits the master guiding bar (32), the size of the slave stick slice (38) fits the slave guiding bar (33), and both the master stick slice (37) and the slave stick slice (38) can principally cover the range of the lubricant splashing from the, master guiding bar (32) and the slave guiding bar (33).

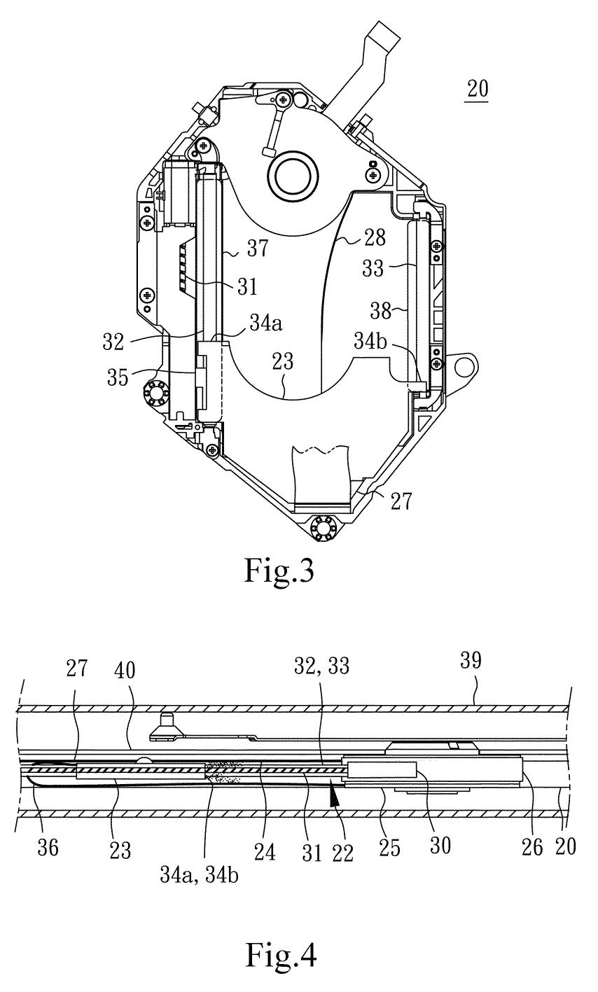

FIG. 3 is a rear view showing the traverse with the splash-proof device according to the first embodiment of the invention. Referring to FIG. 3, the master stick slice (37) is viscidly disposed on the bottom of the protection plate (27) between the master guiding bar (32) and the protection plate (27) and covers an area as the area of vertical projection made by the master guiding bar (32) on the protection plate (27), and the slave stick slice (38) is viscidly disposed on the bottom of the protection plate (27) between the slave guiding bar (33) and the protection plate (27) and covers an area as the area of vertical projection made, by the slave guiding bar (33) on the protection plate (27) in order to cover the range to prevent the lubricant splashing from the two guiding bars (32 and 33) to the protection plate (27). Then, the two slides (34a and 34b) disposed on the two sides of the pick-up head (23) are individually set in the master guiding bar (32) and the slave guiding bar (33) to slide along the master guiding bar (32) and the slave guiding bar (33) and to interlock the protrudent tack (35) and the screw bar (31), and the rack (35) drives the pick-up head (23) along the thread of the screw bar (31) moving within the slot (28).

FIG. 4 is a diagram showing the operation of the traverse with the splash-proof device according to the first embodiment, of the invention. Referring to FIG. 4, when the spindle (26) of the traverse (20) rotates the optical disc (40), the screw bar (31), rotated by the feeding motor (30) of the feeding device (22), rapidly moves the pick-up head (23) to search and read/write the data on the optical disc (40), the data transferred to the optical disk device, (39) via the bus line (36), which has one end connected to the pick-up head 23 and the other end connected to the circuit board (25). When the two slides (34a and 34b) of the pick-up head (23), moving in high speed, slide close to the master guiding bar (32) and the slave guiding bar (33), the fronts of the two slides (34a and 34b) scrape down a part of the lubricant splashing around the moving path along the master guiding, bar (32) and the slave guiding bar (33) as a result of the lubricant thrown off by the pick-up head (23) moving in high speed. The lubricant splashes to the protection plate (27), drops on the splash-proof device (24) viscidly disposed on the bottom of the protection plate (27), and is blocked and absorbed by the splash-proof device (24).

Hence the traverse with the splash-proof device according to the first embodiment of the invention achieves the objective of preventing the lubricant from dropping on, splashing on and tainting the optical disk device and the optical disc by disposing the splash-proof device including the master stick slice and the slave stick slice on the bottom of the protection plate around the master guiding bar and the slave guiding bar that blocks the lubricant from being cumulating on the bottom of the protection plate.

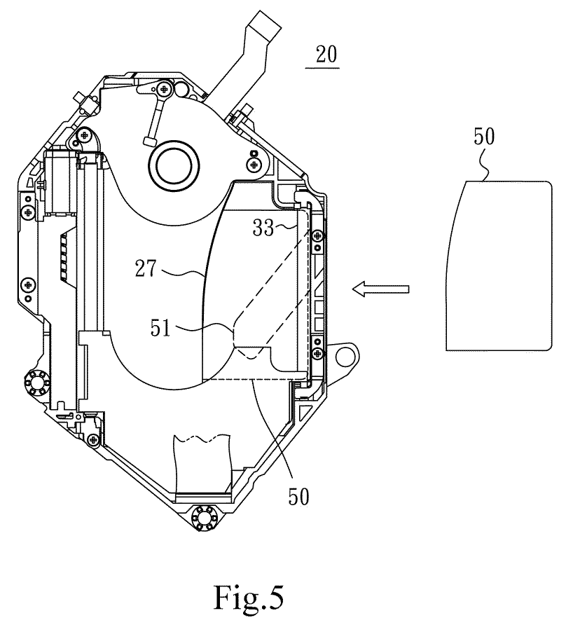

FIG. 5 is a rear view showing the traverse with the splash-proof device (50) according to the second embodiment of the invention. The traverse with a splash-proof device (50) according to the second embodiment has the same basic structure with the traverse according to the first embodiment, so the same components of both embodiments are labeled in same number to simplify the description. The difference between the two traverses of both said embodiments is a through hole (51) dug near the slave guiding bar (33) on the protection plate (27) of the traverse (20) with the splash-proof device (50) according to the second embodiment. To avoid the lubricant splashing on the optical disc through the through hole (51), the stick slice of the splash-proof device (50) according to the second embodiment extends to be viscidly disposed among the range of the bottom of the protection plate (27) and totally covers the through hole (51) to block the lubricant from passing through. Although there is only one through hole (51) for instance in the second embodiment, it should not be construed as a limitation on the actual applicable scope of the invention. With a plurality of through holes (51) dug on the protection plate (27), the slice stick of the splash-proof device (50) could be extended, or the number of it could be increased to cover the through holes (51) in order to prevent the lubricant from passing through to taint the optical disc.

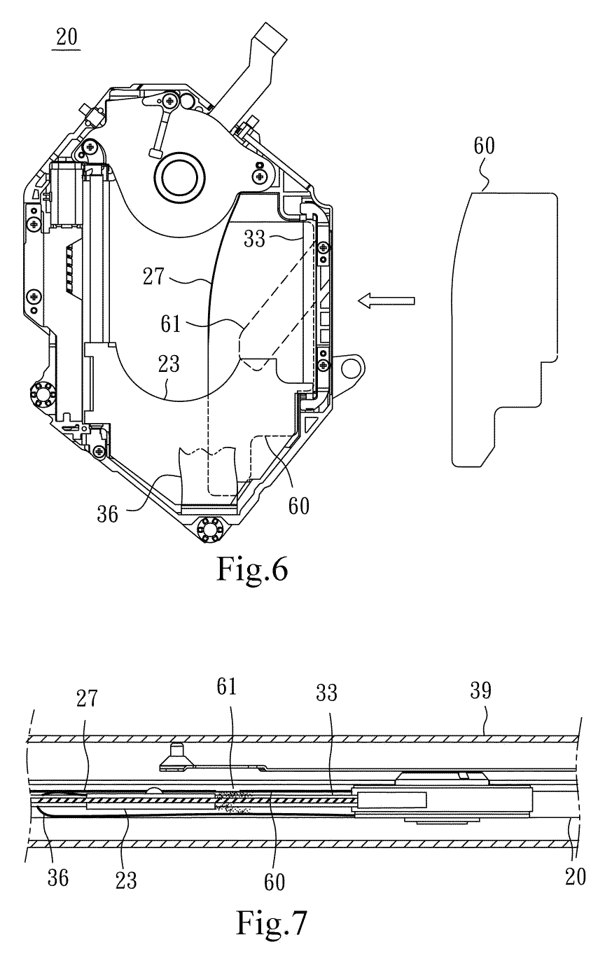

FIG. 6 is a rear view showing the traverse with the splash-proof device (60) according to the third embodiment of the invention. The traverse with a splash-proof device (60) according to the third embodiment has the same basic structure with the traverse according to the first embodiment, so the same components of both embodiments are labeled in same number to simplify the description. The difference between two traverses of both said embodiments is a through hole (61) dug near the s,lave guiding bar (33) on the protection plate (27) of the traverse (20) with the splash-proof device (60) according to the third embodiment. In addition, the stick slice of the splash-proof device (60) in the third embodiment extends to be viscidly disposed among the range of the bottom of the protection plate (27). In addition to totally covering the through hole (61) and the exact range of the vertical projection made by the slave guiding bar (33) on the protection plate (27) or more, the splash-proof device (60) further extends to cover the path that the bus line (36) contacts the bottom of the protection plate (27) among while moving back and forth with the pick-up head.

FIG. 7 is a diagram showing the operation of the traverse with the splash-proof device (60) according to the third embodiment of the invention. The splash-proof device (60) disposed on the bottom of the protection plate (27) not only absorbs the lubricant splashing from the slave guiding bar (33), but also covers the through hole (61) to block the lubricant from passing through and tainting the optical disc. As a result of moving back and forth with the pick-up head (23), the sliding friction has been formed by the contact of the bended bus line (36) and the bottom of the; protection plate (27). In order to strengthen the structure of the protection plate (27), the general metal protection plate (27) easily damages the bus line (36) to short and influences data transfer of the pick-up head (23). After the; splash-proof device (60) of the present invention ex-tends to cover the contact path, the stick slice made by soft material of the splash-proof device (60) could be a buffer and block the bus line (36) from directly contacting the, protection plat (27) to achieve the work against the friction of the bus line (36). Hence the splash-proof device according to the third embodiment of the present invention, which not only prevents the taint from the lubricant but also works against the friction of the bus line, would save the cost of additional wear layer.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A traverse with splash-proof device, which comprises:
a body having one end disposed on a spindle and a top surface covered by a protection plate;
a feeding device disposed inside the body and utilizing a feeding motor to rotate a screw bar near one side of the spindle, and two guiding bars paralleling the screw bar, disposed individually on the two sides of the body;
a pick-up head disposed across two guiding bars, one side of the pick-up head driven by the screw bar to slide along the two guiding bars; and
a splash-proof device disposed on the bottom of the protection plate between the two guiding bars and the protection plate to prevent the lubricant splashed by the two guiding bars.

2. The traverse with splash-proof device according to claim 1, wherein the splash-proof device includes two stick slices, and the size of each stick slice covers a range to prevent the lubricant splashing from the two guiding bars to the protection plate.

3. The traverse with splash-proof device according to claim 2, wherein the two stick slices cover an area as the area of vertical projections made by the two guiding bars on the protection plate.

4. The traverse with splash-proof device according to claim 1, wherein at least one through hole is disposed on the protection plate near the two guiding bars, and the splash-proof device covers the through hole.

5. The traverse with splash-proof device according to claim 1, wherein the pick-up head is connected to a bus line, and the splash-proof device extends to cover the path between the bus line and the bottom of the protection plate contacting the bus line.

6. A traverse with splash-proof device, which comprises:
a body having one end disposed on a spindle and a top surface covered by a protection plate, and at least one through hole disposed on the protection plate;
a feeding device disposed inside the body and utilizing a feeding motor to rotate a screw bar near one side of the spindle, two guiding bars paralleling the screw bar, disposed individually on the two sides of the body, and the through hole located near the to guiding bars;
a pick-up head disposed across two guiding bars, one side of the pick-up head driven by the screw bar to slide along the two guiding bars; and
a splash-proof device disposed on the bottom of the protection plate and covered the through hole.

7. The traverse with splash-proof device according to claim 6, wherein the one of the two guiding bars which is close to the screw bar, is a master guiding bar, the other one of the two guiding bars which is distant from the screw bar, is a slave guiding bar which the through hole are located nearby and the splash-proof device covers a range to prevent the lubricant splashing from the slave guiding bar to the protection plate.

8. The traverse with splash-proof device according to claim 6, wherein the pick-up head is connected to a bus line, and the splash-proof device covers the path between the bus line and the bottom of the protection plate contacting the bus line.

9. The traverse with splash-proof device according to claim 6, wherein the splash-proof device is a stick slice.
